(19) United States
(12) Patent Application Publication
(10) Pub. No.: US 2001/0042097 A1
(43) Pub. Date: Nov. 15, 2001

(54) METHOD AND APPARATUS FOR OPTIONALLY ALERTING INTERNET CLIENTS AND DELIVERING INFORMATION BY WIRELESS NETWORK

(76) Inventor: ANTHONY NELSON LAPINE, LOS GATOS, CA (US)

Correspondence Address: CENTRAL COAST PATENT AGENCY, PO BOX 187, AROMAS, CA, 95004, US

(21) Appl. No.: 09/357,579

(22) Filed: Jul. 20, 1999

(51) Int. Cl. G06F 15/16

(52) U.S. Cl. 709/206; 709/203; 709/217

(57) ABSTRACT

An Internet-connected subscription server provides services to other Internet servers hosted by enterprises wherein enterprises servers planning future events may contract with the subscription server for the subscription server to tabulate clients agreeing to participate in a future event, and then alert the clients by a pager message at or near the time of the future event. In some cases the elicitation of participation and client-specific data enabling the alert may be done by the enterprise server, and in other cases this may be done by the subscription server. With one-way pager systems the alert may simply identify the event and provide the URL of the enterprise host. With two-way pager systems the alert may elicit a response from the client, and may also download further info to a pager on prompting by the client.

### FIELD OF THE INVENTION

The present invention is in the field of Internet subscription services and pertains more particularly to a service for optionally alerting and serving clients via wireless paging systems.

### BACKGROUND OF THE INVENTION

It is well-known in the art that there are many knew and innovative systems and uses being developed and introduced in Internet commerce. It is also well-known that to Interact with enterprise sites on the Internet (WEB servers) a person, herein termed client, must have an Internet capable appliance. The most familiar form of such an appliance is a desktop or notebook-type personal computer (PC) equipped with a modem and browsing software. Lately, however, smaller hand-held devices, such as hand-held computers and personal organizers, loosely termed Personal Digital Assistants (PDAs) are coming into more common use for Internet access and interaction. This is possible because of advances in the computing power of such smaller devices and also advances in Internet connection communication technology.

Typically an Internet-capable appliance, in addition to a modem allowing connection and use of a public switched telephony network (PSTN) and browsing software, also needs software for making a connection to an Internet Service Provider (ISP) and executing a log-on procedure for access to the Internet. Once access is established the appliance allows the client to use the browsing software to access WEB sites by unique addresses termed Universal resource Locators (URLs).

It will be apparent to the skilled artisan that modem connection to a telephone channel to access and ISP for Internet connection, as described above, is exemplary, and that there are a number of other ways, such as by wireless cellular network, satellite network, cable modem, and so forth, through which Internet access may be accomplished.

Regardless of the conventional method and apparatus for Internet access it is still typical that two-way communication with Internet sites for a client still requires an Internet-capable appliance, that is, a computerized apparatus capable of executing browser software, which typically uses a specialized data-packet protocol for two-way communication (HTTP).

The use of specialized HTTP and the fact of increasing sophistication of WEB sites in the amount and multi-media character of the presentations thereon are two of many reasons why the use of smaller and lighter appliances in WEB communication have been slow in coming. These are also two of the reasons why the Internet as a whole, although rapidly growing and becoming more accessible to more people, is still limited to those who have and are experienced in the use of Internet-capable appliances and the software they execute.

What is very much needed is a system which allows Internet communication in many instances to reach beyond the restrictions of Internet sources, Internet-capable appliances, and the conventional paths by which these two connect. The present invention described below provides just such a system.

### SUMMARY OF THE INVENTION

In a preferred embodiment of the present invention an Internet-implemented alert system is provided, comprising a first Internet-connected server hosted by a first enterprise and interacting with clients; a second Internet-connected server hosted by a second enterprise providing services to the first server; and a paging facility coupled to the second server. The first server notifies clients of a future event and requests clients to participate, and the second server, in response to data transferred from the first server, records the future event and pager ID of clients agreeing to participate, and alerts the recorded clients of the event at or near the time of the event.

In some cases the first server elicits client participation and ID from the clients and includes that data in the data transferred to the second server. In other cases clients agreeing to participate in communication with the first server are immediately transferred to the second server, and the second server elicits client ID data. The pager alert at minimum provides just the Universal Resource Locator (URL) of the first server. There may also be message identifying the event.

Using a two-way pager facility alerted clients are enabled to respond to an alert, and responses may be tabulated by the subscription server and transferred to the first server. In some cases clients may be sent additional information according to responses to an alert.

In addition to the apparatus and architecture of the invention, including functional features provided mainly by software, equivalent methods for practicing the invention are provided in various embodiments. For the first time, as a result of the present invention taught in enabling detail below, client participation may not be limited to Internet-bound communication requiring connection to and use of the Internet data packet network.

### BRIEF DESCRIPTION OF THE DRAWING FIGURES

FIG. 1 is a block diagram illustrating an exemplary architecture for a service according to a preferred embodiment of the present invention.

### DESCRIPTION OF THE PREFERRED EMBODIMENTS

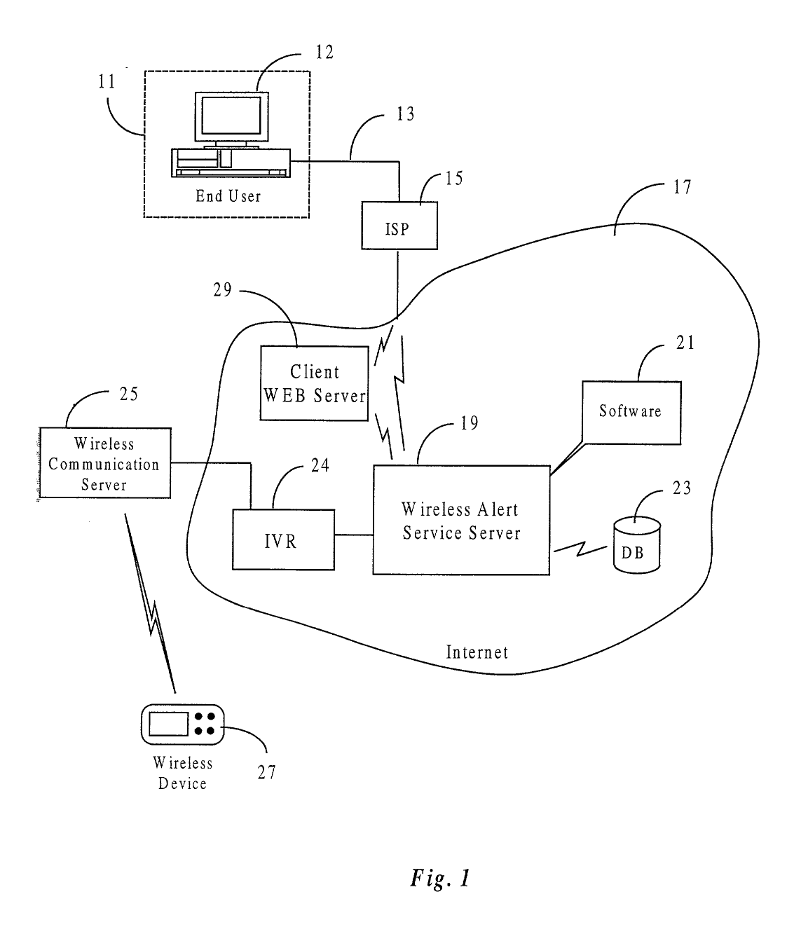

FIG. 1 illustrates an exemplary system architecture for an alert service according to an embodiment of the present invention. In this system an Internet-connected subscription server 19 executes software 21 providing unique services. Server 19 has access to a dedicated database 23 and is connected to an Interactive Telephony server 24 in turn connected to a wireless system server 25 capable of two-way wireless communication with wireless device 27, which represents any number of wireless devices, such as pagers, that might be carried by individual clients of the service.

In this system a client site 11, having a computer with a video display unit (PC/VDU) 12, connects to the Internet network 17 via a telephony channel 13 through an Internet Service Provider 15. This client site and the connection represents a typical computer device connection by telephony modems to the Internet, and it will be apparent to the skilled artisan that there are a broad variety of Internet-capable appliances and connection schemes that may be conventionally assumed for Internet access and interaction, and the present invention is useful with all Internet capable appliances and connection schemes.

Third party WEB server 29 represents the many WEB servers connected to the Internet, many of them e-commerce sites, to which a user at a client site such as site 11 may navigate using suitable browser software and utilizing the well-known convention of Universal Resource Locator (URL) addresses. It will be apparent to the skilled artisan that all WEB servers coupled to the Internet are interconnected by the Internet data packet network and may inter-communicate with one another by asserting URLs of other server sites under management of on-site software at each site. For this reason only exemplary sites are shown and no direct interconnections are shown, although it is understood that wire or wireless connections are assumed. Once a client such as client site 11 is connected to the Internet the client may also practice two-way communication with third-party sites 29 and service server 19.

In typical interaction by a client with WEB servers, particularly e-commerce servers, agreements or transactions may be consummated that require future communication. For example, when a person visits the Amazon.com™ WEB site and places an order for a book, which may be done, for example, using a client site such as site 11, that person is going to be interested in whether and when the book ships. Amazon.com™ typically records the e-mail address of those clients transacting with their WEB site, and through on-site software execution and access to a database storing client data, prepares and sends e-mails to the client informing the client of the progress of his/her order.

In other cases clients visiting third-party sites may register for drawings, request a future contact for another reason, place orders for products in a contingency basis, and make a broad variety of arrangements requiring a future alert and possibly a short message.

In a preferred embodiment of the present invention third party sites such as site 29 are invited to subscribe to an alert and communication service provided by server 19, which is connected to a wireless communication server 25, in this example a paging server, which may send paging messages to wireless devices 27. Subscriber information and profiles are recorded in database 23.

A third party WEB server subscriber may contract a variety of services with service server 29. For example, an e-commerce site in interaction with a client visiting the site will provide hyperlinks a visitor may use to access a page or window for entering client-specific data and initiating a transaction. Again the Amazon.com™ example is useful. A client visiting Amazon.com™ may follow a path of several hyperlinks to order one or more books, and in the process input interfaces are presented to the client to enter delivery and credit information, and so forth.

For a large and successful company like Amazon.com™ having the relatively sophisticated software is not a significant problem. For a lot of smaller e-commerce enterprises, particularly new companies, the transaction interfaces may be a problem.

In one example of the present invention a WEB enterprise may contract with server 29, and post one or more hyperlinks on their own page that will transfer a client to a page at server 29. Such a jump may be made in response to a client's selection of the hyperlink in response to a query on the WEB page having to do with a transaction that will require or benefit from a later response or alert. For example, a WEB enterprise may have plans for a future promotion, and visiting clients who wish to be informed when the promotion begins are invited to select the hyperlink.

Invoking the hyperlink in the example above jumps the client from the enterprise's WEB page to WEB server 29 to a page prepared and operated for the enterprise. The format and operation of the enterprise specific page at server 29 is prepared and put into service as a result of configuration for the enterprise at the time of subscription to services provided by server 29. These services include client notification or alert outside the packet data network of the Internet.

Following the example of a client visiting a WEB page of an enterprise subscribing to services of server 29, wherein the enterprise is providing a future service or presentation, and visiting clients are signing up to be notified, in response to a client initiating the hyperlink in the enterprise's page, server 29 will present the client with a sign-up sheet requesting a wireless address, which may be a pager phone number. The clients connecting to server 29 and entering a pager number to be notified of the WEB enterprise's event are all stored in database 23 for future action.

At the appropriate time the client list for all clients who have been data-logged for notification (alert) for the particular enterprise is recalled and provided to telephony server 24, which outdials the entire list to one or more pager servers 25 which in turn provide a short message to pagers of the appropriate clients. The message is provided in the configuration for each enterprise on server 29, and may be as simple as the URL of the enterprise, suggesting in the alert to the clients that they revisit the enterprise on the WEB.

In the example given immediately above the pager system may be a one-way system, as the alert message to clients is a simple one-way message. In another embodiment the pager system may be a two-way interactive system, and clients may respond, either with a simple acknowledgement, or a short message. In one such embodiment messages to be downloaded to clients may be quite long, and client acknowledgement of each portion of a message will result in a subsequent portion of the longer message being sent. In still other embodiments the client may be queried, and the responses may be selective, such that a more interactive communication ensues.

In some embodiments, as described above, the bulk of client interaction is performed by server 29. In other embodiments more interaction may occur at the subscribing enterprise server, such as for example, clients may be qualified as pager-enhanced before being passed to server 29. In other embodiments the enterprise server may actually prepare lists and pager numbers, and simply transfer the information in bulk to server 29 at or near the time of alert.

It will be apparent to the skilled artisan that there may be a considerable amount of variation in embodiments of the present invention, both in apparatus and method, without departing from the spirit and scope of the invention. For example, as described before, there are a number of ways clients may connect to the Internet, and a number of appliances that may be used. Further there is considerable variation in the ways that the service server 29 may be implemented, and in the range of services that may be provided at server 29, including non-Internet alert. The scope of the invention is limited only by the claims that follow.

What is claimed is:

1. An Internet-implemented alert system, comprising
a first Internet-connected server hosted by a first enterprise and interacting with clients;
a second Internet-connected server hosted by a second enterprise providing services to the first server; and
a paging facility coupled to the second server;
wherein the first server notifies clients of a future event and requests clients to participate, and the second server, in response to data transferred from the first server, records the future event and pager ID of clients agreeing to participate, and alerts the recorded clients of the event at or near the time of the event.

2. The system of claim 1 wherein the first server elicits client participation and ID from the clients and includes that data in the data transferred to the second server.

3. The system of claim 1 wherein clients agreeing to participate in communication with the first server are immediately transferred to the second server, and the second server elicits client ID data.

4. The system of claim 1 wherein the pager alert provides just the Universal Resource Locator (URL) of the first server.

5. The system of claim 4 wherein the pager alert provides the URL and a message identifying the event.

6. The system of claim 1 wherein the paging facility is a two-way facility, and alerted clients are enabled to respond to an alert.

7. The system of claim 6 wherein clients responding to alerts are tabulated by the second server, and data on responses is then transferred to the first server.

8. The system of claim 6 wherein clients are sent additional messages according to responses to an alert.

9. A method for alerting Internet clients of a future event, comprising steps of:
(a) in Internet interaction with the clients by a first internet-connected server hosted by a first enterprise, notifying the clients of the future event and requesting client participation;
(b) transferring data on clients agreeing to participate by the first server to a second Internet-connected server;
(c) recording pager IDs of clients associated with each future event at the second server; and
(d) causing a pager alert to be sent to the clients associated with each future event at or near the time of the event.

10. The method of claim 9 wherein, in step (a), the first server elicits client participation and ID from the clients and includes that data in the data transferred to the second server.

11. The method of claim 9 wherein in step (b) clients agreeing to participate in communication with the first server are immediately transferred to the second server, and in step (c) the second server elicits client ID data.

12. The method of claim 9 wherein in step (d) the pager alert provides just the Universal Resource Locator (URL) of the first server.

13. The method of claim 12 wherein in step (d) the pager alert provides the URL and a message identifying the event.

14. The method of claim 9 wherein the paging facility is a two-way facility, and further comprising a step (e) for clients responding to alerts.

15. The method of claim 14 further comprising a step (f) for tabulating clients responding to alerts by the second server, and transferring data on responses to the first server.

16. The method of claim 14 comprising a further step (f) for sending additional messages according to responses to an alert.
